(19) United States
(12) Patent Application Publication
(10) Pub. No.: US 2002/0114749 A1
(43) Pub. Date: Aug. 22, 2002

(54) Process for removing mercury vapor from flue gas

(76) Inventor: Jerald Alan Cole, Long Beach, CA (US)

Correspondence Address: NIXON & VANDERHYE P.C., 8th Floor, 1100 North Glebe Road, Arlington, VA, 22201-4714, US

(21) Appl. No.: 09/745,014

(22) Filed: Dec. 22, 2000

(51) Int. Cl. B01D 53/64

(52) U.S. Cl. 423/210

(57) ABSTRACT

Process for removing elemental mercury vapor from flue gas which comprises contacting the flue gas with a gaseous oxidizing agent at a gaseous oxidizing agent region to render the elemental mercury vapor more easily oxidized. The flue gas is then subjected to oxidation at a point downstream of the gaseous oxidizing agent region to oxidize the elemental mercury vapor and thereby render it more easily removed.

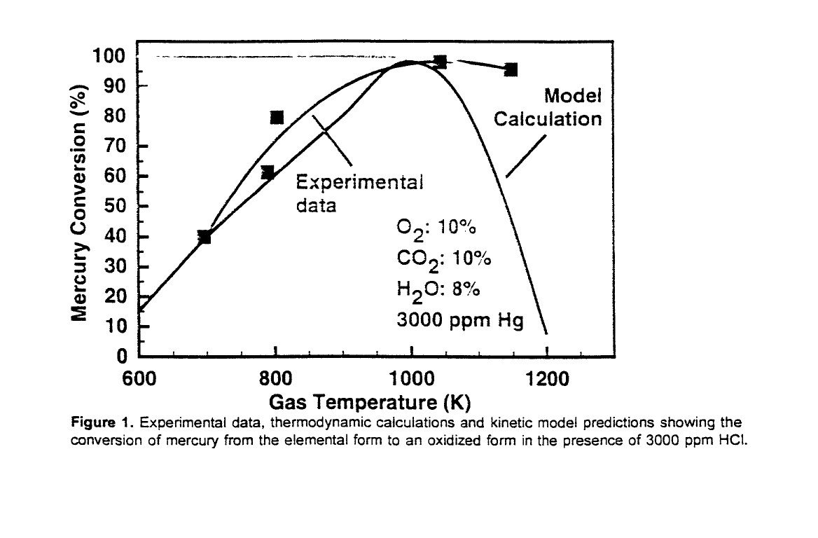

The present invention relates generally to apparatus and methods for removing trace amounts of elemental mercury vapor for the flue gas produced by combustion of coal and other fossil fuels. More specifically, the subject invention relates to an apparatus and method for effecting this removal by adding a gaseous oxidizing agent to the flue gas and subjecting it to an electrical discharge whereby the elemental mercury is oxidized to a form that is readily collected.

### BACKGROUND OF THE INVENTION

Flue gas from coal fired boilers, incinerators, and other combustion systems contains mercury at extremely low concentrations. Some of this mercury is believed to be present in the form of HgCl₂, and some as elemental mercury vapor. The amount of elemental mercury vapor present varies widely. Concentrations as low as 1 ppb or as high as 1 ppm are not uncommon. Existing flue gas scrubbers remove the latter with reasonable efficiency but not the former. Removing the elemental mercury with any of the available technologies would be extremely expensive on a cost per pound of mercury basis because of the low concentration.

The U.S. EPA and others have devoted considerable effort over the past few years toward the study and development of control technologies of these low levels of mercury. It seems likely that in the near future, EPA and agencies of other nations will issue regulations forcing use of one or another process for controlling mercury emissions. If a relatively low cost mercury control technology becomes available, this will increase the probability of EPA's issuing regulations of mercury emissions, i.e. as is frequent in the air pollution control business, developing a technology can create a market for that technology.

A number of prior art references disclose the removal of mercury from flue gas by contacting the flue gas with a sorbent. Frequently, this sorbent is a modified activated carbon, e.g. an activated carbon that has been treated so that its surface contains sulfur, iodine, bromine or precious metals such as gold. Examples of this art include U.S. Pat. No. 4,500,327, No. 5,672,323, No. 5,409,522, No. 4,889,698, No. 5,695,726, No. 6,027,551 and No. 5.827,352. All these and similar prior art references are subject to the same fundamental limitation: the amount of sorbent used and the expense and difficulty of contacting it with the flue gas are related to the amount of flue gas which must be so contacted. Since the amount of flue gas involved is large and the concentration of mercury in it quite small, the cost per pound of mercury removed is very high. EPA estimates of sorbent-based mercury control costs are in the range of $4,940 to $27,700 per pound of mercury removal. Mercury Study Report to Congress, Volume VIII: An Evaluation of Mercury Control Technologies and Costs, Office of Air Quality Planning and Standards and Office of Research and Development, US. Envirommental Protection Agency, Report No. EPA-452/R-97-003. December 1997. More recent estimates by DOE are substantially higher. Brown, T., O'Dowd, Wm., Reuther, R. and Smith, D., Control of Mercury Emission from Coal-Fired Power Plants: A Preliminary Cost Assessment. Draft Report. U.S Department of Energy Federal Energy Technology Center. Jul. 10,1998.

Another approach involves modifying the aqueous phase chemistry of the scrubbing process so as to increase the extent to which these chemical processes remove mercury from the gas phase. U.S. Pat. No. 5,900,042 describes a process in which the flue gas is contacted with an oxidizing solution. U.S. Pat. No. 5,435,980 describes a process in which SO₂ emissions are controlled by a spray drying system. Removal of SO₂ with a spray drying system resembles SO₂ removal with a wet scrubbing system. In both cases, an aqueous spray that contains a base (typically CaO) is injected into the flue gas. In the case of the spray drying system, however, this contacting is done with a gas temperature well above the boiling point of water. Consequently as the spray removes the SO₂, the water in it evaporates and the final collected product is a dry solid. U.S. Pat. No. 5,435,980 discloses the modification of this method of removing SO₂ so as to increase the amount of mercury that is removed along with the SO_{2.} This is achieving by addition of chloride ion to the scrubbing solution, either directly by adding CaCl₂ to the solution or indirectly by adding HCl to the flue gas, the HCl being highly water soluble and immediately dissolving in the sprayed solution. While the examples of U.S. Pat. No. 5,435,980 show that chloride addition can provide improved mercury removal without the use of active carbon, they do not show quantitative mercury removal.

Numerous prior art references have discussed technologies in which any of several types of electrical discharges is used to remove SO₂ and NOx. S. Masuda (Control of Air Toxic Material by Novel Plasma Chemical Process—PPCP and SPCP. In: Managing Hazardous Waste: State of the Art. EPRI, CRC Press. 1993) has pointed out that this approach can also oxidize mercury vapor, thereby facilitating its removal and that the presence of HCl at concentrations greater than 300 ppm facilitated this removal. This may be relevant to incinerators since the concentration of HCl in flue gas from incinerators varies widely often ranging from 1 ppm to 5000 ppm. It is, however, clearly not relevant to flue gas from coal firing which typically contains only 30 ppm HCl and often much less.

There is a need in the art for a new and lower cost technology for control of mercury emissions. The present invention seeks to meet that need.

### SUMMARY OF THE INVENTION

The present invention seeks to convert elemental mercury contained in combustion flue gases and similar gas streams into a readily removed oxidized form at substantially lower incremental costs than have been projected for other methods of controlling mercury emissions. The present invention also seeks to effect such conversion without producing a secondary waste stream such as contaminated active carbon which has special requirements or restrictions on disposal. The present invention further aims to effect the conversion in a manner that interfaces efficiently with the air pollution control equipment currently used to control SO₂, NOx and particulate emissions on coal fired combustion systems and on incinerators.

In a first aspect, the present invention provides a process for removing elemental mercury vapor from flue gas which comprises contacting the flue gas in an oxidizing agent region with a gaseous oxidizing agent, typically Cl₂, an oxide of chlorine, H₂O₂, and/or HOCl, to render the elemental mercury vapor more easily oxidized, and subjecting the flue gas to oxidation, typically by way of an electrical discharge, at a point downstream of the oxidizing agent region to oxidize the elemental mercury vapor and thereby render it more easily removed from the flue gas.

An important advantage arising from this invention is the unexpected cost savings due to reduced energy requirements as compared to conventional processes such as activated carbon injection. In particular, it has been discovered that the combined use of an oxidizing agent and an electical discharge drastically decreases the electrical power consumption and the expense of controlling mercury vapor emissions.

### BRIEF DESCRIPTION OF THE DRAWINGS

The invention will now be described with reference to the accompanying FIGURE which is a plot of mercury conversion (%) as a function of gas temperature.

### DETAILED DESCRIPTION OF THE INVENTION

The present invention resides in the surprising discovery that the oxidation of mercury is initiated by reaction with an oxidizing agent in a fast non-activated raction. As a result of this discovery, it is now possible to remove elemental mercury vapor from flue gas by oxidation of the mercury to HgCl₂, HgSO₄, HgO and/or other oxidized mercury species. The flue gas is contacted with an oxidizing agent, typically a gaseous oxidation agent selected from Cl₂, the oxides of chlorine, H₂O₂, HOCl, other compounds of chlorine, the halogens F₂, Br₂, I₂ and Kr₂ and their compounds, and sulfur species, including but not limited to H₂S, SO₃, H₂SO₄, CH₃SH, CH₂S, in order to render the mercury species more easily oxidized. The amount of the gaseous oxidizing agent is generally less than 100 ppm by volume, for example 30-80 ppm, more usually 40-60 ppm, and at a temperature that is typically less than 500° C., for example 250-400° C.

The contacting with the gaseous oxidizing agent is performed at a point upsteam of a device which generates free radicals by means of an electrical discharge or by means of electromagnetic radiation. Examples are by way of visible or ultraviolet light, or by microwave corona discharge, or by a short pulse spark discharge.

The free radicals may consist of the species H., OH., O., Cl., F., Br., I., Kr.., HS., S., HO₂., CH₃., and/or CH₂.. In one embodiment, the free radical generator device is a wet electrostatic precipitator. The electric discharge device operates at a temperature that is usually less than 300° C. and more usually in the range of 100° C. to 50° C. The free radicals produced by the electric discharge or other means trigger the oxidation of the elemental mercury by the oxidizing agent to HgCl₂ and/or HgO which is collected by means known in the art. Examples of such means include the wet electrostatic precipitator and wet scrubbing.

While not bound to any theory, it is believed that, in coal combustion flue gas, the radicals generated by a corona discharge are altered by a chain reaction sequence involving SO₂ and NO. One of the main sources of the radicals produced by a corona discharge is H₂O which is split to produce H. and OH.. The OH. reacts with HCl to produce the chlorine atoms necessary for initiation of mercury oxidation by formation of species such as HgCl.. Completion of the oxidation of HgCl. radicals then occurs through reaction with oxidizing moieties such as chlorine and HOCl. The H. radical reacts with O₂ to produce HO₂., a relatively stable radical which may in fact be responsible for direct oxidation of mercury to HgO. However, in coal combustion flue gas, NO is much more prevalent than Hg and consumes HO₂. through the reaction:

NO+HO₂.=NO₂+OH.

The OH. so produced generates an additional chlorine atom that can increase the rate of mercury oxidation. As part of the SO₂/NO chain reaction sequence, some of the OH can also react with SO₂, which is relatively abundant in coal combustion flue gases. This reaction believed to proceed through the following steps:

OH.+SO₂=HSO₃.

HSO₃.+O₂=SO₃+HO₂.

HO₂.+NO=OH.+NO₂

Thus, OH. that reacts with SO₂ is not consumed, but merely acts as a catalyst for the oxidation of SO₂ and NO to produce SO₃ and NO. The chain length of this reaction sequence is about 100 (varying somewhat depending on the temperature and gas composition), and so it has a negligible net impact on the availability of OH. for reaction with HCl.

Following collection of HgCl₂ and/or other oxidized mercury species, the collected material is generally treated with sulfide ion to convert the HgCl₂ and/or HgO to HgS. As is well known to those skilled in the art, HgS is not soluble in water and is a form in which mercury occurs naturally in the environment. Thus, by converting mercury into this form, secondary waste generation is avoided.

The use of other means for stabilizing, precipitating, sequestering or otherwise separating dissolved mercury from the liquid which are well known to those skilled in the art are also part of this invention.

### EXAMPLES

The following examples serve to illustrate the present invention

### Comparative Example 1

A series of experiments was carried out in a laboratory-scale reactor in which a simulated flue gas containing 10% O₂, 10% CO₂, 8% H₂O, 3000 ppm HCl and traces of elemental mercury vapor were allowed to react for one second and the extent of removal of the elemental mercury vapor was measured as a function of temperature with the results shown in the FIGURE. The FIGURE shows the experimental data, thermodynamic calculations and kinetic model predictions showing the conversion of mercury from the elemental form to an oxidized form in the presence of 3000 ppm HCl.

Table 1 below gives reaction rate parameters used for the study of mercury reactions in coal combustion flue gas. Rate paramters are for reaction rate constants of the form k_{f}=A·T^{-B}·exp[−Ea/R·T].

TABLE 1

| | | | | | Eₐ | ΔH_{r×n} |
|---|---|---|---|---|---|---|
| | | | A | | kcal · | kcal · |
| No. | Reaction | | cm³-mol-s | B | mol⁻¹ | mol⁻¹ |
| 1 | Hg + Cl + M | = HgCl + M | 2.40E+08 | −1.4 | −14.4 | −23.6 |
| 2 | Hg + Cl₂ | = HgCl + Cl | 1.39E+14 | 0 | 34.0 | +34.0 |
| 3 | Hg + HOCl | = HgCl + OH | 4.27E+13 | 0 | 19.0 | +33.6 |
| 4 | Hg ± HCl | = HgCl + H | 4.94E+14 | 0 | 79.3 | +79.3 |
| 5 | HgCl + Cl₂ | = HgCl₂ + Cl | 1.39E+14 | 0 | 1.0 | −26.0 |
| 6 | HgCl ± HCl | = HgCl₂ + H | 4.94E+14 | 0 | 21.5 | +19.1 |
| 7 | HgCl + Cl + M | = HgCl₂ + M | 2.19E+18 | 0 | 3.1 | −84.1 |
| 8 | HgCl ± HOCl | = HgCl₂ + OH | 4.27E+13 | 0 | 1.0 | −26.9 |

The computer model shown in Table 1 was assembled from the literature using measured values for the rate constants if they were available and estimates based on analogy with similar reactions if they were not. This computer model was then used to calculate the “Model Calculation” curve shown in the FIGURE The HSC thermodynamic equilibrium program was used to calculate the “Calculated Equilibrium” curve also shown in the FIGURE.

### Comparative Example 2

The kinetic model described above was used to model the experimental results of the Masuda reference. In this calculation, the rate at which an electrical discharge produces free radicals was taken as an adjustable parameter, i.e. it was assumed that the rate of free radical production was directly proportional to the discharge power and the constant of this proportionality was chosen so that the model's predictions agreed with Masuda's experimental data. From Masuda's experiments, it is possible to calculate that achievement of 90% oxidation of elemental mercury vapor for the flue gas coming from a 100 MWₑ coal fired boiler would require an electrical discharge with a power of 780 kW, if the flue gas contained 300 ppm HCl. For a more realistic concentration of 30 ppm HCl, the power requirement increases to 7.6 MW. This illustrates that the methods of removing mercury with an electrical discharge as described in the prior art involve either impractically large power consumption or impractically high concentrations of HCl.

### EXAMPLE

Using the model, the effect of adding 30 ppm Cl₂ was calculated for 90% mercury removal from the flue gas of a 100 MWₑ coal fired boiler. Assuming that the flue gas contained 30 ppm HCl, the effect of adding 30 ppm Cl₂ was to decrease the electrical power consumed by the discharge from 7.6 MW to only 150 kW, a decrease by a factor of 50.7. This illustrates that the addition of a trace of an oxidizing agent drastically decreases the electrical power consumption and the expense of controlling mercury vapor emissions.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A process for removing elemental mercury vapor from flue gas which comprises:
contacting the flue gas with a gaseous oxidizing agent at a gaseous oxidizing agent region to render the elemental mercury vapor more easily oxidized; and
subjecting the flue gas to oxidation at a point downstream of the gaseous oxidizing agent region to oxidize the elemental mercury vapor and thereby render it more easily removed.

2. A process according to claim 1, wherein the gaseous oxidizing agent is selected from the group consisting of Cl₂, the oxides of chlorine, H₂O₂, HOCl, compounds of chlorine, F₂, Br₂, I₂ and Kr₂ and their compounds, and sulfur species.

3. A process according to claim 2, wherein the sulfur species is selected from H₂S, SO₃, H₂SO₄, CH₃SH and CH₂S.

4. A process according to claim 1, wherein the flue gas contains HCl in a range of I to 30 ppm, elemental mercury vapor in a range of I ppb to I ppm, and the gaseous oxidizing agent is Cl₂.

5. A process according to claim 4, wherein the amount of Cl₂ contacted with the flue gas is in the range of 1 to 30 ppm.

6. A process according to claim 1, wherein the elemental mercury vapor is contacted with free radicals.

7. A process according to claim 1, wherein the elemental mercury vapor is subjected to an electric discharge.

8. A process according to claim 7, wherein the flue gas is subjected to the electric discharge at a temperature of less than 300° C.

9. A process according to claim 8, wherein the temperature at which the flue gas is subjected to the electric discharge is in the range of 100° C. to 50° C.

10. A process according to claim 6, wherein the oxidation of the elemental mercury vapor occurs within an electrostatic precipitator.

11. A process according to claim 1, wherein the oxidation of the elemental mercury vapor is initiated by electromagnetic radiation.

12. A process according to claim 11, wherein the electromagnetic radiation is visible or ultraviolet light.

13. A process according to claim 1, wherein the oxidation of the elemental mercury vapor is initiated by microwave energy.

14. A process for removing elemental mercury vapor from flue gas which comprises:
contacting the flue gas with a gaseous oxidizing agent selected from the group consisting of Cl₂, an oxide of chlorine, H₂O₂, and HOCl at a gaseous oxidizing agent region to render the elemental mercury vapor more easily oxidized; and
subjecting the flue gas to an electrical discharge at a point downstream of the gaseous oxidizing agent region to oxidize the elemental mercury vapor and thereby render it more easily removed.

15. A process according to claim 14, wherein the electrical discharge is generated by a microwave corona.

16. A process according to claim 14, wherein the electrical discharge is a short pulse spark discharge.
